(19) United States
(12) Patent Application Publication
(10) Pub. No.: US 2025/0242619 A1
(43) Pub. Date: Jul. 31, 2025

(54) PRINTING APPARATUS A NON-TRANSITORY COMPUTER-READABLE STORAGE MEDIUM STORING A PRINT DATA GENERATION PROGRAM

(71) Applicant: SEIKO EPSON CORPORATION, Tokyo (JP)

(72) Inventor: Masaharu IWAMOTO, SHIOJIRI-SHI (JP)

(21) Appl. No.: 19/034,728

(22) Filed: Jan. 23, 2025

(30) Foreign Application Priority Data
Jan. 26, 2024 (JP) 2024-010419

(51) Int. Cl. B41J 29/393; B41J 13/10; G06F 3/12

(52) U.S. Cl. CPC B41J 29/393; B41J 13/103; G06F 3/1208; G06F 3/1242; G06F 3/1253

(57) ABSTRACT

A printing apparatus including a printing unit includes an operation unit including a display unit, and a printing control unit that controls the printing unit based on a printing condition acquired via the operation unit. The printing control unit can execute a cover installation mode of disposing a cover for each media bundle when ejecting a plurality of media bundles that is bundles of printed media, and the printing control unit performs printing of a header on the cover based on the printing position acquired via the user interface.

The present application is based on, and claims priority from JP Application Serial Number 2024-010419, filed Jan. 26, 2024, the disclosure of which is hereby incorporated by reference herein in its entirety.

### BACKGROUND

### 1. Technical Field

The present disclosure relates to a printing apparatus that performs printing. Further, the present disclosure also relates to a non-transitory computer-readable storage medium storing a print data generation program.

### 2. Related Art

A technique of inserting an interleaving sheet between a plurality of print materials is publicly known in the related art. The printing apparatus disclosed in JP-A-2017-182714 can put an interleaving sheet on which image data is printed, on each of a plurality of print materials ejected to an ejection tray. In JP-A-2017-182714, the image data to be printed on the interleaving sheet includes the group names, the names of absent members, the number of copies to be printed, and the date.

In JP-A-2017-182714, the position of the image data to be printed on the interleaving sheet is fixed, without taking usability into consideration.

### SUMMARY

For achieving the above-described problems, a printing apparatus of the present disclosure includes a printing unit configured to perform printing on a medium, an operation unit configured to accept various operation settings and including a display unit configured to display a variety of information, and a printing control unit configured to cause the display unit to display a plurality of user interfaces, the printing control unit being configured to control the printing unit based on a printing condition acquired via the operation unit, wherein the printing control unit is configured to execute a cover installation mode of disposing a cover for each of a plurality of media bundles when the plurality of media bundles are ejected, the plurality of media bundles being bundles of printed media, the cover installation mode is configured to perform printing of a header on the cover, and the printing control unit is configured to accept, via the user interface, a setting of a printing position in the printing of the header on the cover, and perform printing of the header based on the printing position acquired.

In addition, a non-transitory computer-readable storage medium of the present disclosure stores a print data generation program of generating print data based on an acquired printing condition, the print data generation program being configured to cause a computer to execute: displaying on a display device a user interface that accepts a setting of a printing position of a header for a case of disposing a cover at a media bundle that is a bundle of printed media and printing the header on the cover, and generating print data in which the printing position acquired via the user interface is included in the printing condition.

### BRIEF DESCRIPTION OF THE DRAWINGS

FIG. 1 is a front view of a printing apparatus.

FIG. 2 is a block diagram illustrating a configuration of a printing control unit.

FIG. 3 is a front view of an operation panel.

FIG. 4 is a flowchart illustrating a flow of processing performed by the printing control unit.

FIG. 5 is a diagram illustrating a UI displayed on a touch panel.

FIG. 6 is a diagram illustrating a UI displayed on a touch panel.

FIG. 7 is a diagram illustrating a UI displayed on a touch panel.

FIG. 8 is a diagram illustrating a UI displayed on a touch panel.

FIG. 9 is a diagram illustrating a UI displayed on a touch panel.

FIG. 10 is a diagram illustrating a UI displayed on a touch panel.

FIG. 11 is a diagram illustrating an example of the output order of the print materials.

FIG. 12 is a diagram illustrating an example of the output order of the print materials.

FIG. 13 is a diagram illustrating an example of the output order of the print materials.

FIG. 14 is a diagram illustrating an example of the output order of the print materials.

FIG. 15 is a diagram illustrating an example of an output state of a print material in shift printing.

FIG. 16 is a diagram illustrating an example of an output state of a printing unit when changing an orientation of a cover.

FIG. 17 is a block diagram illustrating a configuration of a computer capable of communicating with the printing apparatus.

### DESCRIPTION OF EMBODIMENTS

The present disclosure is briefly described below. A printing apparatus according to a first aspect includes a printing unit configured to perform printing on a medium, an operation unit configured to accept various operation settings and including a display unit configured to display a variety of information, and a printing control unit configured to cause the display unit to display a plurality of user interfaces, the printing control unit being configured to control the printing unit based on a printing condition acquired via the operation unit, the printing control unit is configured to execute a cover installation mode of disposing a cover for each of a plurality of media bundles when the plurality of media bundles are ejected, the plurality of media bundles being bundles of printed media, the cover installation mode is configured to perform printing of a header on the cover, and the printing control unit is configured to accept, via the user interface, a setting of a printing position in the printing of the header on the cover, and perform printing of the header based on the printing position acquired.

According to this aspect, the printing control unit is configured to accept, via the user interface, a setting of a printing position in the printing of the header on the cover, and perform printing of the header based on the printing position acquired, and therefore the header can be printed at a convenient location for the user, thus improving the usability.

In a second aspect according to the first aspect, the printing control unit performs printing of the header on a surface that is a top surface of the cover in a state where the cover is disposed on the media bundle.

According to this aspect, the printing control unit performs printing of the header on a surface that is a top surface of the cover in a state where the cover is disposed on the media bundle, and thus the header can be easily visually recognized. Note that the state where the cover is disposed on the media bundle is not limited to the state where the media bundle is ejected first and then the cover ejected on the media bundle, but includes a state where the cover is ejected before the media bundle such that the media bundle is disposed on the cover, and then the media bundle is turned over together with the cover.

In a third aspect according to the first aspect, vertical writing and horizontal writing of letters of the header are selectable via the user interface. According to this aspect, vertical writing and horizontal writing of letters of the header are selectable via the user interface, and thus the usability can be further improved. Note that this aspect may depend not only on the first mode, but also on the second mode.

In a fourth aspect according to the first aspect, a size of the letters of the header is settable via the user interface. According to this aspect, a size of the letters of the header is settable via the user interface, and thus the usability can be further improved. Note that this aspect may depend not only on the first mode, but also on the second or third mode.

In a fifth aspect according to the first aspect, a font of the letters of the header is settable via the user interface. According to this aspect, a font of the letters of the header is settable via the user interface, and thus the usability can be further improved. Note that this aspect may depend not only on the first mode, but also on any of the second to fourth aspects.

In a sixth aspect according to the first aspect, a plurality of the printing positions is settable via the user interface. According to this aspect, a plurality of the printing positions is settable via the user interface, and thus the usability can be further improved. Note that this aspect may depend not only on the first mode, but also on any of the second to fifth aspects.

In a seventh aspect according to the first aspect, the cover installation mode is configured to perform shift ejection of alternately shifting an ejection position of the media bundle, and the printing control unit is configured to accept, via the user interface, a region shifted by the shift ejection as the printing position.

According to this aspect, since the header is printed in the region shifted by the shift ejection, the header can be visually recognized, and the usability can be further improved. Note that this aspect may depend not only on the first mode, but also on any of the second to sixth aspects.

An eighth according to the first aspect, further includes a first medium cassette configured to house the medium with a short side direction of the medium aligned with a supplying direction, and a second medium cassette configured to house the medium with a long side direction of the medium aligned with the supplying direction, the cover installation mode is configured to eject the cover and the media bundle in different orientations by appropriately using the first medium cassette and the second medium cassette, and the printing control unit is configured to accept, via the user interface, a region that does not overlap the media bundle in the cover as the printing position.

According to this aspect, since the header is printed in the region that does not overlap the media bundle in the cover, the header can be visually recognized, and the usability can be further improved. Note that this aspect may depend not only on the first mode, but also on any of the second to sixth aspects.

In a ninth aspect according to the first aspect, the printing control unit is configured to accept, via the user interface, a setting of a number of copies of print materials associated with a plurality of main groups, a plurality of subgroups belonging to one of the main groups, and one of the subgroups, and when one main group among the plurality of main groups is selected and then a printing execution command in the cover installation mode is accepted, the printing control unit disposes the cover on the media bundle that is a bundle of the print materials belonging to one of the subgroups.

According to this aspect, when one main group among the plurality of main groups is selected and then a printing execution command in the cover installation mode is accepted, a cover is disposed on the media bundle that is a bundle of the print materials belonging to one of the subgroups, and thus the usability is further improved.

A non-transitory computer-readable storage medium according to a tenth aspect stores a print data generation program of generating print data based on an acquired printing condition, the print data generation program being configured to cause a computer to execute displaying on a display device a user interface that accepts a setting of a printing position of a header for a case of disposing a cover at a media bundle that is a bundle of printed media and printing the header on the cover, and generating print data in which the printing position acquired via the user interface is included in the printing condition.

According to this aspect, since the printing position of the header can be set, the header can be printed at a convenient location for the user, thus improving the usability.

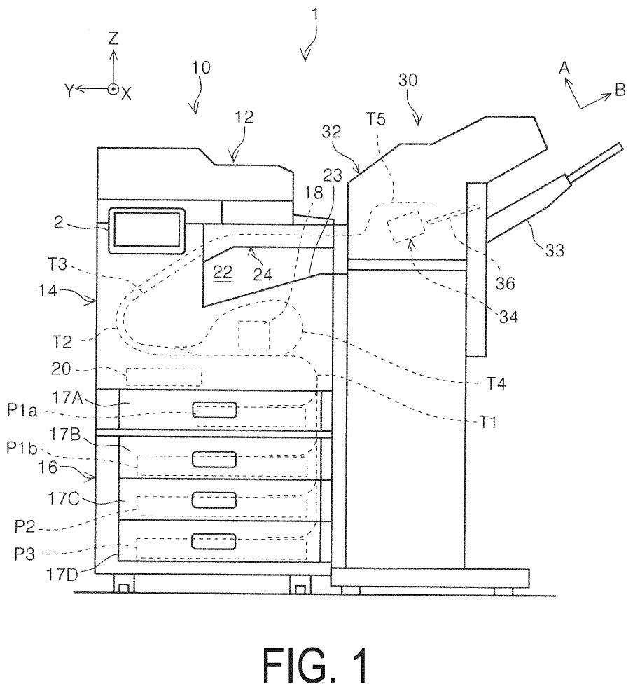

Hereinafter, the present disclosure will be described in detail. A printing apparatus 1 according to an embodiment of the present disclosure is described below. In each of the drawings, an X-axis direction is an apparatus depth direction of the printing apparatus 1. A +X direction of the X-axis direction, which is a direction in which an arrow faces, is a direction from an apparatus rear surface toward an apparatus front surface, and a −X direction is a direction from the apparatus front surface toward the apparatus rear surface. In addition, the X-axis direction is an example of a width direction of a medium. A Y-axis direction is an apparatus width direction of the printing apparatus 1, a +Y direction of the Y-axis direction, which is a direction in which an arrow faces is a left direction when viewed from a user facing the apparatus front surface, and a −Y direction is a right direction. A Z-axis direction is an apparatus height direction of the printing apparatus 1, and is a vertical direction, a +Z direction, which is a direction in which an arrow faces, is a vertically upward direction, and a −Z direction is a vertically downward direction. In the following description, the +Z direction may be simply referred to as an upward direction and the −Z direction may be simply referred to as a downward direction. Note that in FIG. 1, the +A direction is the direction that is the normal to the placing surface of a main tray 33 described later and includes the +Z direction component, and the +B direction is the direction that is parallel to the placing surface of the main tray 33 and includes the +Z direction component.

Note that in an example described below, the printing apparatus 1 is installed in a school staff room and used by school staff, including teachers, to print printed materials to be distributed to students, but naturally the use of the printing apparatus 1 is not limited to this. For example, it may be placed in homes, businesses, home offices, public facilities, stores, and other locations and used for various purposes.

As illustrated in FIG. 1, the printing apparatus 1 includes a printing unit 10 and a post-processing unit 30. The printing unit 10 according to this embodiment is an ink-jet printer that performs printing by ejecting ink as an example of liquid onto a medium typified by a printing sheet, and includes a line head 18 as an example of a printing unit. Note that the term “printing” may be referred to as “recording”. In addition, the printing unit 10 is a so-called multifunctional apparatus including a scanner unit 12 on the upper part of the apparatus, and the copy function, scanner function, facsimile machine function and the like are implemented using the scanner unit 12. Implementation of the copy function in the printing apparatus 1 especially entails the printing operation of the printing unit 10. It should be noted that the printing unit 10 is not limited to the ink-jet printer, but may be configured to perform printing by other methods such as laser printers, heat transfer printers, and dot impact printers, for example.

The printing unit 10 includes a main body part 14, a medium housing part 16 that houses a medium, a medium conveyance unit (not illustrated in the drawing) that conveys a medium, the line head 18, an in-body ejection unit 22 to which the medium is ejected, and a relay unit 24 that conveys the medium to the post-processing unit 30. In addition, the printing unit 10 includes a printing control unit 20 that performs general control of the printing apparatus 1, and an operation panel 2 serving as an operation unit that receives various setting operations and displays a variety of information.

Medium housing part 16 includes, from the upper side, a first medium cassette 17A, a second medium cassette 17B, a third medium cassette 17C, and a fourth medium cassette 17D. The first medium cassette 17A houses a first medium P1a. The first medium P1a is, for example, an A4 sheet, and is housed with the short side direction aligned along the supplying direction. The second medium cassette 17B houses a first medium P1b. The first medium P1b is, for example, an A4 sheet, and is housed with the long side direction aligned along the supplying direction.

The third medium cassette 17C houses a second medium P2. The second medium P2 is, for example, an A4 sheet, and is housed with the long side direction aligned along the supplying direction. In addition, the second medium P2 is, as an example, a medium of a type different from that of the first medium P1b, in particular, is different in color from the first medium P1b, and can function to indicate a boundary between print materials when interposed between the print materials. The second medium P2 is used mainly as a cover or an interleaving sheet described later.

The fourth medium cassette 17D houses a third medium P3. The third medium P3 is, for example, an A4 sheet, and is housed with the long side direction aligned along the supplying direction. In addition, the third medium P3 is, as an example, a medium of a type different from that of the first medium P1b and the second medium P2. More specifically, the third medium P3 is different in color from the first medium P1b and the second medium P2, and can function to indicate a boundary between print materials when interposed between the print materials. The third medium P3 is used mainly as a cover or an interleaving sheet described later.

Note that naturally the cover or interleaving sheet described later may be composed of any of the first medium P1a and the first medium P1b. In addition, any of the first medium P1a and the first medium P1b may be used as print materials other than covers or interleaving sheets. In addition, a plurality of medium cassettes may not be necessarily provided, and it suffices that at least the first medium P1a or the first medium P1b for printing is housed.

A conveyance path for conveying the medium is provided inside the main body part 14. The reference symbol T1 represents a supplying path through which the medium fed from each medium cassette is supplied to a position opposite to the line head 18 described later. The reference symbol T2 represents an ejection path through which a medium on which recording has been performed is ejected. The reference symbol T3 represents a switchback path to which the medium is fed in both-side recording of the medium and which performs switch-back of the medium. The reference symbol T4 represents a reversal path to which the medium is fed from the switchback path T3 and which reverses the medium.

The line head 18 includes a plurality of ink ejecting nozzles (not illustrated in the drawing) disposed corresponding to the entirety of the X-axis direction of the medium, i.e., the width direction. The line head 18 performs printing on the medium by ejecting ink supplied from an ink tank (not illustrated in the drawing) from the plurality of ink ejection nozzles toward the medium.

The medium that has been subjected to printing in the printing unit 10 is ejected to the relay unit 24 through the ejection path T2, and further fed to the post-processing unit 30 through the relay unit 24. The post-processing unit 30 includes an apparatus main body 32. The apparatus main body 32 includes a stapler 34 as an example of a processing tray 36 and the post-processing unit, an ejection unit (not illustrated in the drawing) that ejects the medium that has been subjected to post-processing to the main tray 33, and the main tray 33 provided outside the apparatus main body 32. The main tray 33 is an example of the ejection tray that receives the ejected medium. Note that the printing apparatus 1 according to this embodiment is configured such that the medium is sent to the post-processing unit 30 with the relay unit 24 provided in the in-body ejection unit 22. It is also possible to adopt a configuration in which the relay unit 24 and the post-processing unit 30 are omitted such that the medium is loaded on the in-body ejection tray 23 provided in the in-body ejection unit 22.

The medium delivered from the relay unit 24 to the apparatus main body 32 is conveyed along a conveyance path T5 inside the apparatus main body 32 and sent to the processing tray 36. The medium is temporarily loaded on the processing tray 36, and is ejected to the main tray 33 by the ejection unit (not illustrated in the drawing) after necessary post-processing is performed when the post-processing is performed. Note that the post-processing unit 30 is provided with a rear end alignment unit (not illustrated in the drawing), and a rear end (a rear end in the +Y direction) of the medium on the processing tray 36 is aligned by the rear end alignment unit. In addition, a side cursor (not illustrated in the drawing) is provided at the processing tray 36, and a side end on the processing tray 36 in the width direction (X-axis direction) is aligned by the side cursor. In addition, the side cursor allows for shift ejection that is performed for ejection while alternately shifting the width direction position in ejection of a medium to the main tray 33. The main tray 33 is movable in the vertical direction, and moves down as the medium is loaded.

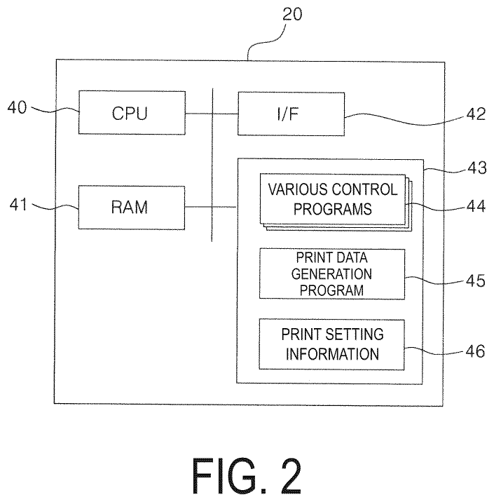

The printing control unit 20 controls the entire printing apparatus 1 including the line head 18 based on a printing condition acquired via the operation panel 2. As illustrated in FIG. 2, the printing control unit 20 includes a CPU 40, a RAM 41, an I/F 42, and a non-volatile memory 43, which is an example of a storage medium. The CPU 40 loads various control programs 44 and a print data generation program 45, which will be described later, stored in the non-volatile memory 43 into the RAM 41, which is a volatile memory, and executes the programs. The various control programs 44 include various programs for controlling the printing unit 10 and the post-processing unit 30. Further, the non-volatile memory 43 stores print setting information 46 input and accepted via the operation panel 2. In view of the above functions, the printing control unit 20 can also be referred to as an information processing apparatus or a computer.

Various functions of the printing apparatus 1 are implemented when the CPU 40 executes the various control programs 44. Further, the CPU 40 executes the print data generation program 45 to generate print data for printing performed by the printing unit 10. For example, when the copy function of the printing apparatus 1 is used, the print data is generated based on image data generated by reading a document by the scanner unit 12 and the print setting information 46. The I/F 42 is a communication interface for coupling the printing apparatus 1 to a local area network (LAN).

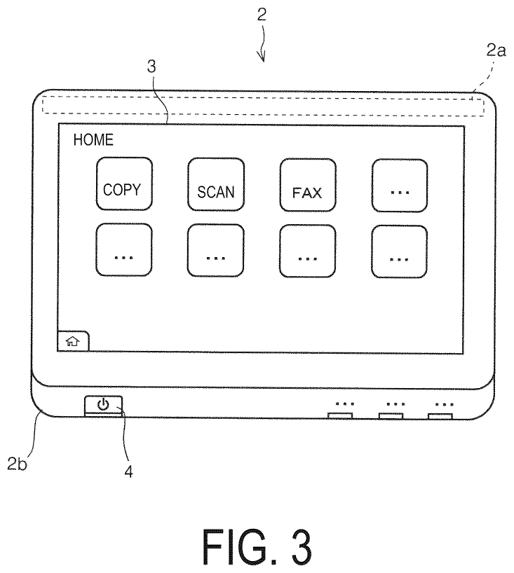

Next, the operation panel 2 will be described with reference to FIG. 3. The operation panel 2 is an example of an operation unit that includes a touch panel 3 that is a display unit that displays various information, and accepts various operation settings. The operation panel 2 is provided at the main body part 14 of the printing unit 10 via a rotary shaft 2a, and is provided such that a tilt angle can be adjusted through rotation around the rotary shaft 2a. Further, in the embodiment, the rotary shaft 2a is configured as a free stop hinge such that an optional tilt angle can be held.

The operation panel 2 includes a front surface formed of a cover glass, the touch panel 3 at a lower layer thereof, and a liquid crystal display unit (not illustrated in the drawing) at a further lower layer thereof. For the touch panel 3, a capacitance type, a resistance film type, an optical type, an electromagnetic induction type, and the like are known, but in the embodiment, the capacitance type is used. A user's operation on the operation panel 2 is basically a touch operation on the touch panel 3 in the embodiment. An outer shell of the operation panel 2 is configured by a housing 2b, and a power button 4 for turning on and off power supply of the printing apparatus 1 is arranged below the touch panel 3 in the housing 2b.

A user interface is implemented at the touch panel 3 under the control of the printing control unit 20. The term “user interface” is referred to as “UI” for convenience in the following description. The various control programs 44 (see FIG. 2) includes programs for implementing various UIs. The following description assumes that when the processes and operations of the printing apparatus 1 are described based on various UIs, the processes and operations are implemented when the printing control unit 20 executes the various control programs 44 and the print data generation program 45 described later. In particular, when the printing control unit 20 executes the print data generation program 45, the cover installation mode described later is implemented. The UI illustrated in FIG. 3 is a home screen on which icons named “COPY”, “SCAN”, “FAX” and the like are displayed, and the user touches one of the icons corresponding to the operation to be performed.

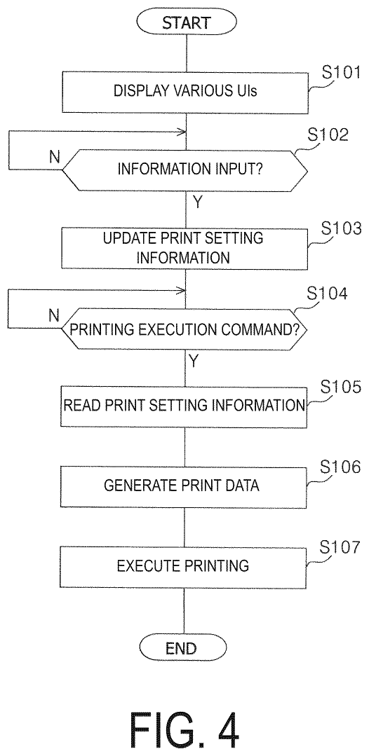

Next, an overview of the processing performed by the printing control unit 20 will be described with reference to FIG. 4. The printing control unit 20 displays the various UIs on the touch panel 3 (step S101). When a user inputs information via the various UIs (Yes in step S102), the printing control unit 20 updates the print setting information 46 (step S103). Then, when a print execution command is received (Yes in step S104), the printing control unit 20 reads the print setting information 46 (step S105), generates print data based on the print setting information 46 (step S106), and performs printing (step S107).

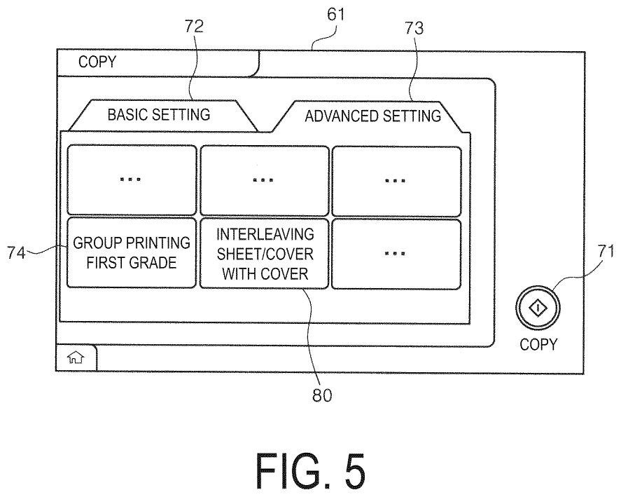

The following describes transitions of the UIs in an example case where “COPY” is selected on the home screen of FIG. 3. When the copy function is selected, the printing control unit 20 displays a UI 61 including a basic setting tab 72 and an advanced setting tab 73 as illustrated in FIG. 5. The UI 61 displays the basic setting tab 72 by default, but FIG. 5 illustrates a state where the advanced setting tab 73 is selected. Note that although contents of the basic setting tab 72 are (not illustrated in the drawing), basic copy settings such as selection of color printing or monochrome printing, setting of print density, paper setting, and print magnification can be made in the basic setting tab 72. In addition, an execution button 71 for performing copying, that is, document reading and printing is displayed on a lower right side of the UI 61. Tapping of the execution button 71 corresponds to the print execution command illustrated in step S104 of FIG. 4.

In the advanced setting tab 73, items other than the items that can be set in the basic setting tab 72 can be set, and for example, an icon 74 for setting group printing, an icon 80 for performing setting related to interleaving sheets and covers are displayed. Note that the icon 80 may be displayed in another UI that is displayed by tapping the icon 74. Note that although not illustrated in FIG. 5, the advanced setting tab 73 displays icons for a binding process using the post-processing unit 30 and saving data read by the scanner unit 12, and the like.

The icon 74 is an icon for proceeding to setting of group printing, and indicates the name of the currently selected main group among a plurality of main groups described later. In the example of FIG. 5, “FIRST GRADE” is displayed as an example of the selected main group. When the execution button 71 is tapped in this state, group printing is executed with the setting of “FIRST GRADE” described later. Note that when none of the plurality of main groups is selected, “OFF” is displayed instead of “FIRST GRADE”, and the function of group printing is turned off.

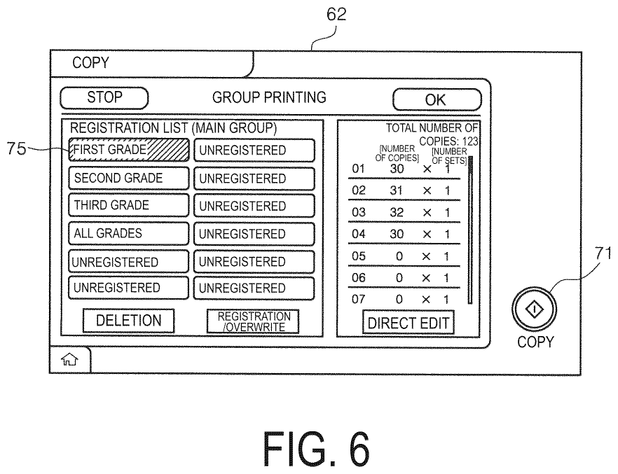

When the icon 74 is tapped, the UI transitions to a UI 62 illustrated in FIG. 6. In the UI 62, a plurality of main groups is displayed in a registration list, and in the example of FIG. 6, four main groups of “FIRST GRADE”, “SECOND GRADE”, “THIRD GRADE” and “ALL GRADES” are registered. When an icon of each main group is pressed for a long time, the UI transitions to a name input UI (not illustrated in the drawing), and a name of the main group can be input or changed. In addition, when the icon of each main group is tapped shortly, the icon can be brought into a selected state. Further, when the icon in the selected state is tapped shortly, the icon can be brought into an unselected state. Only one icon can be brought into the selected state from the plurality of main groups.

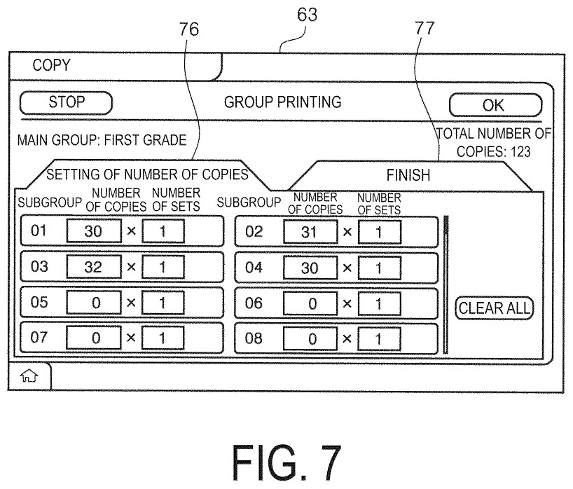

In the example of FIG. 6, an icon 75 indicating the main group of “FIRST GRADE” is in the selected state. A color of the icon of each main group changes from light to dark when the icon is brought into the selected state, so that the icon can be distinguished from other unselected icons. Further, each registered main group can be brought into an “UNREGISTERED” state by tapping a “DELETE” icon. Further, when the “REGISTER/OVERWRITE” icon is tapped in a state where any one of the plurality of main groups is selected, the UI transitions to a UI 63 illustrated in FIG. 7. Further, when the “DELETE” icon is tapped in a state where any one of the plurality of main groups is selected in FIG. 6, the setting of the selected main group can be deleted and “UNREGISTERED” can be displayed. In addition, when the “OK” icon is tapped in FIG. 6, the print setting information 46 (see FIG. 2) is updated with the contents set so far, and the UI returns to the UI 61 in FIG. 5. In addition, when the “CANCEL” icon in FIG. 6 is tapped, the contents set so far are discarded and the print setting information 46 (see FIG. 2) is not updated, and, the UI returns to the UI 61 in FIG. 5.

On the right side of the registration list in FIG. 6, the setting contents of the selected main group, specifically, subgroups to be described later and the number of copies to be printed and the number of sets to be printed associated with each of the subgroups are displayed. In addition, the total number of copies for the selected main group is displayed. In this state, the number of copies to be printed and the number of sets to be printed are grayed out, and by tapping a “DIRECT EDIT” icon, the number of copies and the number of sets can be directly edited. The UI 62 in FIG. 6 also displays the execution button 71, and when the execution button 71 is tapped, group printing is executed with the setting of the currently selected “FIRST GRADE”.

The UI 63 of FIG. 7 displays a number-of-copies setting tab 76 and a finish tab 77, and the number-of-copies setting tab 76 is displayed by default. The number-of-copies setting tab 76 displays a plurality of subgroups and the number of copies to be printed and the number of sets to be printed associated with each subgroup. When the number indicating the number of copies to be printed is tapped, the number indicating the number of copies to be printed is brought into the selected state, and the number of copies to be printed can be set using a numeric keypad (not illustrated in the drawing). Similarly, when the number indicating the number of sets to be printed is tapped, the number indicating the number of sets to be printed is brought into the selected state, and the number of sets to be printed can be set using the numeric keypad (not illustrated in the drawing). Note that for the subgroup name, as with the main group name, pressing the subgroup name for a long time may cause transition to the name input UI (not illustrated in the drawing) such that the desired name can be set.

Now the number of copies to be printed and the number of sets to be printed are described. For example, when the number of copies to be printed is “30” and the number of sets to be printed is set to “1”, one set of “30” copies is printed. Similarly, when the number of copies to be printed is “30” and the number of sets is set to “2”, two sets of 30 copies are printed, i.e., 60 copies are printed for the selected subgroup. In this example, the print materials printed by the designated number of copies and designated number of sets are “media bundle” for which a cover may be disposed. In the following description, the “media bundle” may be a group of print materials for which the cover may be disposed. For example, when the number of copies to be printed is “30” and printing is executed with the number of sets is set to “1” in the cover installation mode described later, one cover is disposed for a media bundle as the print materials printed by one set of “30” copies. Note that in the case where the main group is set to “FIRST GRADE” as in this example, assigning each subgroup as each class of the first grade can make it easy to intuitively understand.

When the “OK” icon of FIG. 7 is tapped, the print setting information 46 (see FIG. 2) is updated with the contents set so far, and the UI returns to the UI 62 in FIG. 6. In addition, when the “CANCEL” icon in FIG. 7 is tapped, the print setting information 46 (see FIG. 2) is not updated, and the UI returns to the UI 62 in FIG. 6.

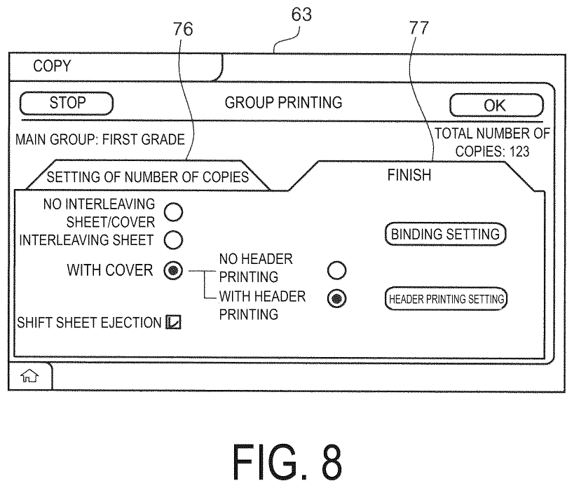

Next, FIG. 8 illustrates a state where the finishing tab 77 is selected in the UI 63. In the finishing tab 77, one of “no interleaving sheet/cover”, “with interleaving sheet”, and “no cover” is selected with the radio button. When “no interleaving sheet/cover” is selected, neither interleaving sheet nor cover is disposed. When “with interleaving sheet” is selected, interleaving sheets are disposed between a plurality of media bundles. Specifically, the printing control unit 20 executes the interleaving sheet installation mode of placing interleaving sheets between the plurality of media bundles. When “with cover” is selected, a cover is disposed for each of a plurality of media bundles.

Specifically, the printing control unit 20 executes the cover installation mode of placing a cover for each of the plurality of media bundles. Note that it is possible to display a pull-down menu for selecting the first medium cassette 17A, the second medium cassette 17B, the third medium cassette 17C, or the fourth medium cassette 17D illustrated in FIG. 1 from which the interleaving sheet or cover is to be fed.

In addition, in the finishing tab 77, when “with cover” is selected, one of “no header printing” and “with header printing” can be selected with the radio button. Note that when “with cover” is not selected, the indication of “no header printing” and “with header printing” and each radio button are grayed out in a non-selectable state. In addition, in the finishing tab 77, the execution/non-execution of shift sheet ejection can be selected at the check box.

In the case where the shift sheet ejection is checked, the shift sheet ejection described later is implemented.

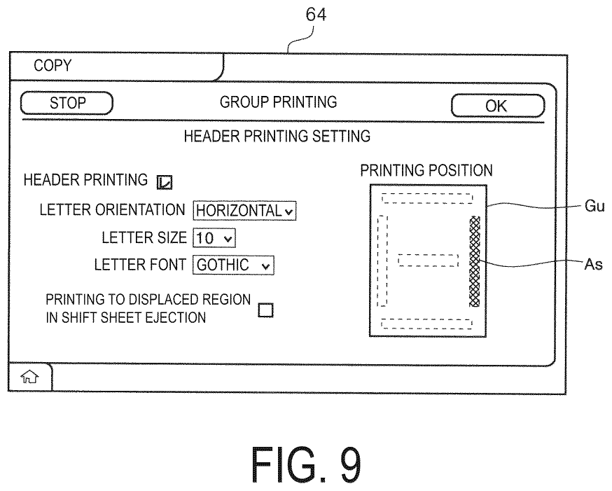

In addition, in the finishing tab 77, when the binding setting button is pressed, the UI transitions to an UI not illustrated in the drawing to allow the binding setting to be performed. Here, the binding setting is the execution/non-execution of the binding process using the post-processing unit 30 (FIG. 1) and the binding position. In addition, in the finishing tab 77, the UI transitions to a UI 64 illustrated in FIG. 9 when the header printing setting button is pressed to allow setting of the header printing to be performed. Note that when the “OK” icon in FIG. 8 is tapped, the print setting information 46 (see FIG. 2) is updated with the contents set so far, and the UI returns to the UI 62 in FIG. 6. In addition, when the “CANCEL” icon in FIG. 8 is tapped, the print setting information 46 (see FIG. 2) is not updated, and the UI returns to the UI 62 in FIG. 6.

In the UI 64 illustrated in FIG. 9, the execution/non-execution of header printing can be selected at the check box. When the header printing is checked, the header printing described later is implemented. In addition, in the UI 64, the orientation of letters in the header printing can be selected from “horizontal” and “vertical” from the drop down list. In addition, in the UI 64, the letter size in the header printing can be selected from the drop down list. In addition, in the UI 64, the letter font in the header printing can be selected from the drop down list. In addition, in the UI 64, the execution of printing in the displaced region when the shift sheet ejection is selected can be selected at the check box. When this check box is checked, a header is printed in the displaced region described later.

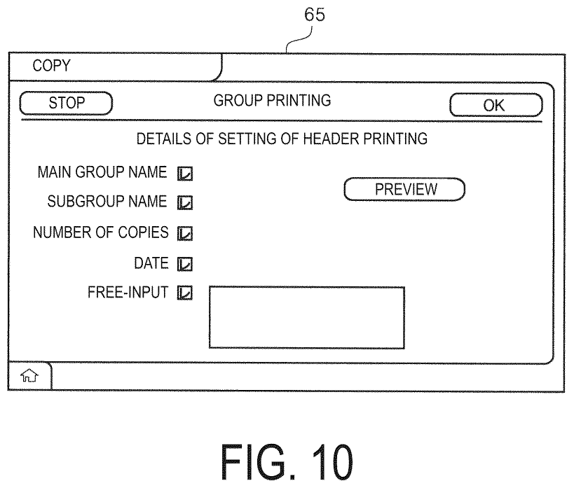

In addition, in the UI 64, the image of the cover is displayed as indicated by the reference symbol Gu, and further the region of the printing position of the header in the cover is displayed. The display of the region of the printing position is disposed in each of the upper part, lower part, center part, right side, and left side of the cover, and can be selected by tapping it shortly. Note that as an example, the direction from the lower part to the upper part in the display is the sheet eject direction. The region selected by tapping is displayed with a strong color, and in the example illustrated in FIG. 9, the right side region is selected as indicated by the reference symbol As. When each region is further tapped for a long time, the UI transitions to a UI 65 illustrated in FIG. 10. Note that when shift sheet ejection is selected and the execution of printing to the displaced region is checked, the cover image is grayed out, and the selection of the printing region is prohibited. In this case, the printing region is automatically set. Note that when “OK” icon in FIG. 9 is tapped, the print setting information 46 (see FIG. 2) is updated with the contents set so far, and the UI returns to the UI 63 in FIG. 8. In addition, when the “CANCEL” icon in FIG. 9 is tapped, the print setting information 46 (see FIG. 2) is not updated, the UI returns to the UI 63 of FIG. 8.

In the UI 65, details of the header printing can be set. As an example, the main group name, subgroup name, the number of copies, date, and free-input can be selected by checking the check box. The selected item is printed as a header. In addition, when the check box “free-input” is checked and the text input box on its right side is pressed for a long time, a letter input UI (not illustrated in the drawing) is displayed to allow input of desired letters. The letters input here are also printed as a header. In the UI 65, a preview button is displayed, and the preview of the header printing can be displayed by tapping the preview button. Note that when the “OK” icon in FIG. 10 is tapped, the print setting information 46 (see FIG. 2) is updated with the contents set so far, and the UI returns to the UI 64 in FIG. 9. In addition, when the “CANCEL” icon in FIG. 10 is tapped, the print setting information 46 (see FIG. 2) is not updated, and the UI returns to the UI 65 in FIG. 9.

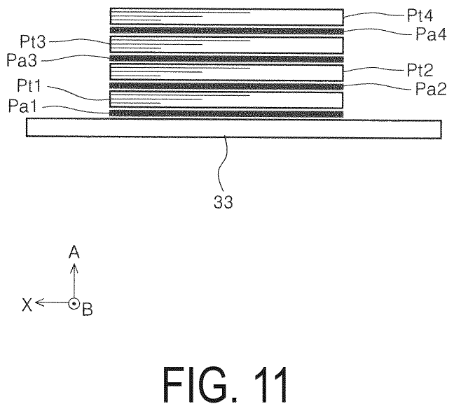

FIG. 11 illustrates a case where ejection to the main tray 33 is performed with the printing surface of the cover facing down, i.e., a case of face-down ejection of covers. The reference symbols Pa1, Pa2, Pa3 and Pa4 represent covers. The reference symbols Pt1, Pt2, Pt3 and Pt4 represent media bundles. The media bundle Pt1 is, for example, the print materials of “subgroup 01” illustrated in FIG. 7, i.e., the print materials of 30 copies, and the same applies to the media bundles Pt2, Pt3 and Pt4 hereinafter. In addition, the cover Pa1 is a cover disposed for the media bundle Pt1, and the same applies to the covers Pa2, Pa3 and Pa4 hereinafter.

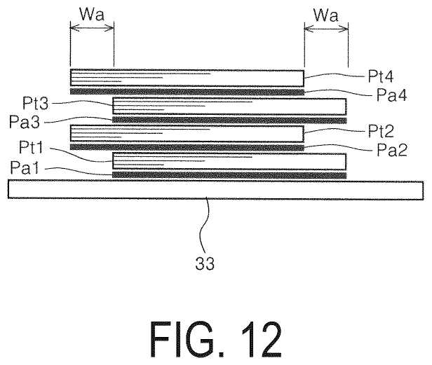

In the case illustrated in FIG. 11, the cover corresponding to the media bundle is ejected before the media bundle. In the case where each media bundle and each cover are ejected as illustrated in FIG. 11, the printing surface of the cover Pa1, i.e., the header faces up when the entire load on the main tray 33 is turned over. Note that the current printing surface in each media bundle in the state of FIG. 11 is on the lower side as with each cover, but may be on the upper side. FIG. 12 illustrates a case of shift ejection.

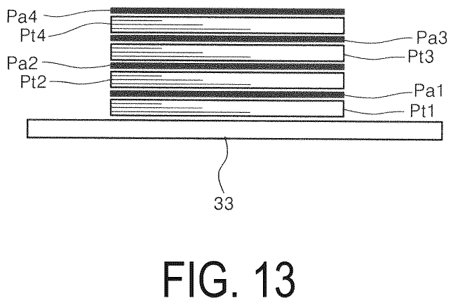

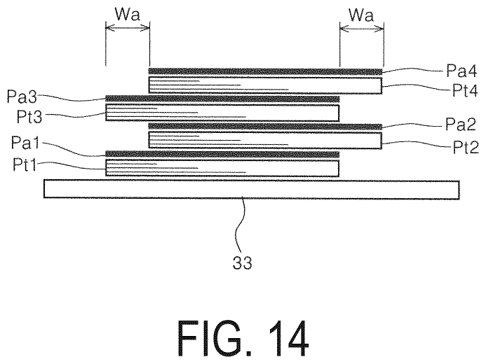

FIG. 13 illustrates a case where ejection to the main tray 33 is performed with the printing surface of the cover facing up, i.e., a case of face-up ejection of covers. In the case illustrated in FIG. 13, the cover corresponding to the media bundle is ejected after the media bundle. In the case illustrated in FIG. 13, the printing surface of each cover faces up, and therefore the printing surface of each cover, i.e., the header can be visually recognized without turning over the entire load on the main tray 33. Note that in the state of FIG. 12, the current printing surface of each media bundle faces up as with each cover, but may face down. FIG. 14 illustrates a case of shift ejection.

Note that which of the stacking order of the cover and media bundle illustrated in FIGS. 11 and 12 and the stacking order of the cover and media bundle illustrated in FIGS. 13 and 14 is used may be set from the UI. In addition, the printing surface for printing the header on each cover may be set from the UI. In addition, not only printing of the header on one surface of the cover, but also printing on both surfaces may be set from the UI.

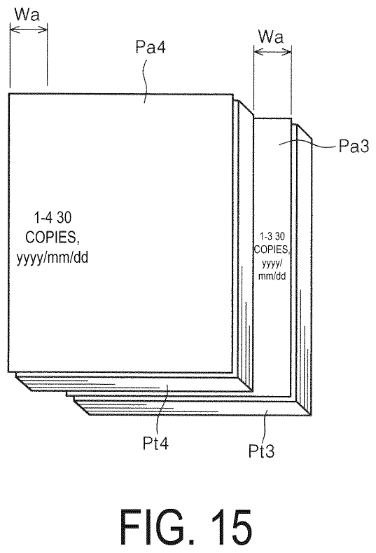

Note that when shift sheet ejection is selected and the execution of printing to the displaced region is checked (see FIG. 9), the header is printed in the region shifted by the shift ejection. In FIGS. 12 and 14 the reference symbol Wa represents the region shifted by the shift ejection, i.e., displaced region. The displaced region Wa is a region that is not hidden by another media bundle when that media bundle is stacked on the cover. FIG. 15 illustrates the cover Pa4, the media bundle Pt4, the cover Pa3 and the media bundle Pt3 among the print materials illustrated in FIG. 14, and the header is printed in the displaced region Wa as illustrated in the drawing.

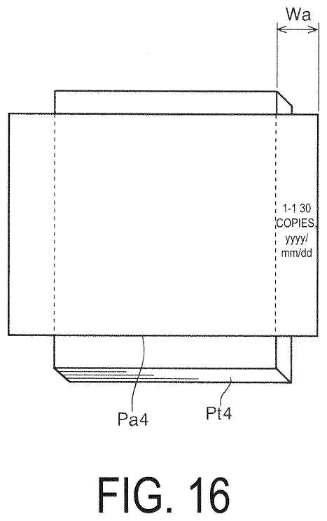

Note that instead of printing in the displaced region formed by the shift sheet ejection, the cover and the media bundle may be ejected in different orientations as illustrated in FIG. 16 so as to perform printing in the region in the cover that does not overlap the media bundle. FIG. 16 illustrates the media bundle Pt4 and the cover Pa4 as an example, and the reference symbol Wa is the region where the media bundle Pt4 does not overlap the cover Pa4. In the case where shift sheet ejection is not performed, the region Wa where the cover Pa4 does not overlap the media bundle Pt4 is a region that is not hidden by the media bundle even when another media bundle is further stacked on it.

The above-described printing apparatus 1 includes the operation panel 2, which is an operation unit that accepts various operation settings and includes the touch panel 3, which is a display unit that displays a variety of information. In addition, the printing apparatus 1 includes the printing control unit 20 that causes the touch panel 3 to display a plurality of UIs, and controls the printing unit based on a printing condition acquired via the operation panel 2. The printing control unit 20 can execute the cover installation mode of disposing the cover for each of a plurality of media bundles, which are bundles of printed media, when the plurality of media bundles are ejected. The cover installation mode can print the header on the cover, and the printing control unit 20 can accept via the UI the setting of the printing position for printing the header on the cover, and performs printing of the header based on the acquired printing position. In addition, the print data generation program 45 to generate print data based on the acquired printing condition causes the printing control unit 20 to execute a step (step S101 in FIG. 4) of displaying on the touch panel 3 the UI (see FIG. 9) that accepts setting of the printing position of the header when disposing the cover at a media bundle, which is a bundle of printed media and printing the header on the cover, and a step (step S106 in FIG. 4) of generating print data in which the printing position acquired via the UI is included in the printing condition. In this manner, the header can be printed at a convenient location for the user, thus improving the usability.

In addition, the printing control unit 20 performs printing of the header on the top surface of the cover in the state where the cover is disposed on the media bundle. Thus the header can be easily visually recognized. Note that the state where the cover is disposed on the media bundle is not limited to the state where the media bundle is ejected first and the cover is ejected onto the media bundle, but includes a state where the cover is ejected before the media bundle such that the media bundle is disposed on the cover, and then the media bundle is turned over together with the cover.

In addition, in this embodiment, the vertical writing and horizontal writing of the letters of the header can be selected via the UI (see FIG. 9). The distinction between the vertical writing and horizontal writing includes distinction between “vertical writing” and “horizontal writing” and the distinction between “portrait orientation” and “landscape orientation”. In addition, in this embodiment, the size of the letters of the header can be set via the UI (see FIG. 9). In addition, in this embodiment, the font of the letters of the header can be set via the UI (see FIG. 9). In addition, in this embodiment, a plurality of printing positions can be set via the UI (see FIG. 9). In this manner, according to this embodiment, and the usability can be further improved.

In addition, the printing control unit 20 can perform shift ejection of alternately shifting the ejection position of the media bundle in the cover installation mode, and can accept via the UI the region shifted by the shift ejection as the printing position (see FIG. 9). In this manner the header is printed in the region shifted by the shift ejection, and therefore the header can be visually recognized, thus further improving the usability.

In addition, the printing apparatus 1 according to this embodiment includes the first medium cassette 17A that houses the medium with the short side direction of the medium aligned with the supplying direction, and the second medium cassette 17B that houses the medium with the long side direction of the medium aligned with the supplying direction. The printing control unit 20 can eject the cover and the media bundle in different orientations by appropriately using the first medium cassette 17A and the second medium cassette 17B in the cover installation mode. Further, the printing control unit 20 can accept via the UI the region that does not overlap the media bundle in the cover (in FIG. 16, the displaced the region Wa) as the printing position. In this manner, the header is printed in the region that does not overlap the media bundle in the cover, and therefore the header can be visually recognized, thus further improving the usability.

In addition, the printing control unit 20 according to this embodiment can accept via the UI the setting of the number of copies of the print materials associated with a plurality of main groups, a plurality of subgroups belonging to one main group, and one subgroup. Further, when one main group is selected from among a plurality of main groups and then the printing execution command is accepted in the cover installation mode, the printing control unit 20 disposes the cover on a media bundle that is a bundle of the print materials belonging to one subgroup. In this manner, the usability is further improved.

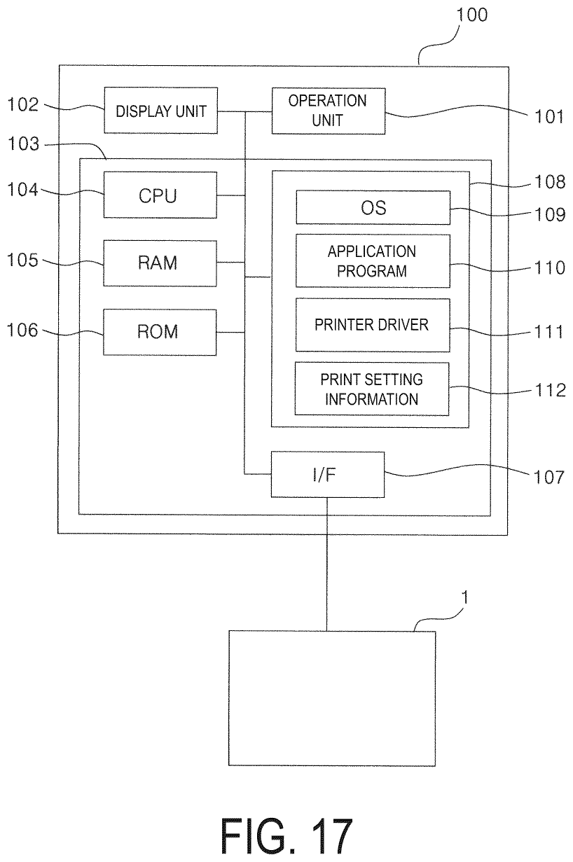

In the above-described embodiment, the copy function is executed via the operation panel 2 of the printing apparatus 1, but computer 50 (see FIG. 17) that can access the printing apparatus 1 can also implement the same function as that of the print data generation program 45.

In FIG. 17, a computer 100 is composed of an operation unit 101, a display unit 102, a CPU 104, a RAM 105, a ROM 106, a storage 108, an I/F 107, and the like. The storage 108 is composed of an HDD (hard disk drive), an SSD (solid-state drive) or the like. The storage 108 stores an operating system (hereinafter referred to as “OS”) 109, an application program 110, a printer driver 111, and a print setting information 112.

The CPU 104 executes various programs and the like stored in the ROM 106 and/or the storage 108 by loading them in an RAM 105, which is a volatile memory. The operation unit 101 is composed of a pointing device such as a keyboard, a mouse and a touch pad. The display unit 102 is composed of a liquid crystal display and the like. On the display unit 102, various UIs are implemented by the OS 109, the application program 110, the printer driver 111 and the like. The I/F 107 is a communication interface for connecting the computer 100 to a communication network such as a local area network.

The application program 110 is a program that operates under the OS 109, such as document creation software. The printer driver 111 is a program for implementing the same function as that of the above-described print data generation program 45, and is an example of the print data generation program. The printer driver 111 generates print data that can be sent to the printing apparatus 1 in accordance with the data generated by the application program 110 and the print setting information 112.

The UI implemented by the printer driver 111 on the display unit 102 may be the same as each UI illustrated in FIGS. 5 to 10. Specifically, the printer driver 111 that generates print data based on the acquired printing condition causes the computer 100 to execute a step (step S101 in FIG. 4) of displaying on the display unit 102 the UI (see FIG. 9) for accepting the setting of the printing position of the header when disposing the cover at a media bundle, which is a bundle of printed media and printing the header on the cover, and a step (step S106 in FIG. 4) of generating print data in which the printing position acquired via the UI is included in the printing condition. In this manner, the user of the computer 100 can perform printing of the header at a convenient position, thus improving the usability.

The present disclosure is not limited to the embodiments and modifications described above, and it is obvious that various modifications are possible within the scope of the disclosure described in the claims, and these are also included in the scope of the present disclosure.

What is claimed is:

1. A printing apparatus comprising:
a printing unit configured to perform printing on a medium;
an operation unit configured to accept various operation settings and including a display unit configured to display a variety of information; and
a printing control unit configured to cause the display unit to display a plurality of user interfaces, the printing control unit being configured to control the printing unit based on a printing condition acquired via the operation unit, wherein
the printing control unit is configured to execute a cover installation mode of disposing a cover for each of a plurality of media bundles when the plurality of media bundles are ejected, the plurality of media bundles being bundles of printed media,
the cover installation mode is configured to perform printing of a header on the cover, and
the printing control unit is configured to accept, via the user interface, a setting of a printing position in the printing of the header on the cover, and perform printing of the header based on the printing position acquired.

2. The printing apparatus according to claim 1, wherein the printing control unit performs printing of the header on a surface that is a top surface of the cover in a state where the cover is disposed on the media bundle.

3. The printing apparatus according to claim 1, wherein vertical writing and horizontal writing of letters of the header are selectable via the user interface.

4. The printing apparatus according to claim 1, wherein a size of the letters of the header is settable via the user interface.

5. The printing apparatus according to claim 1, wherein a font of the letters of the header is settable via the user interface.

6. The printing apparatus according to claim 1, wherein a plurality of the printing positions is settable via the user interface.

7. The printing apparatus according to claim 1, wherein
the cover installation mode is configured to perform shift ejection of alternately shifting an ejection position of the media bundle, and
the printing control unit is configured to accept, via the user interface, a region shifted by the shift ejection as the printing position.

8. The printing apparatus according to claim 1, further comprising:
a first medium cassette configured to house the medium with a short side direction of the medium aligned with a supplying direction; and
a second medium cassette configured to house the medium with a long side direction of the medium aligned with the supplying direction, wherein
the cover installation mode is configured to eject the cover and the media bundle in different orientations by appropriately using the first medium cassette and the second medium cassette, and
the printing control unit is configured to accept, via the user interface, a region that does not overlap the media bundle in the cover as the printing position.

9. The printing apparatus according to claim 1, wherein
the printing control unit is configured to accept, via the user interface, a setting of a number of copies of print materials associated with a plurality of main groups, a plurality of subgroups belonging to one of the main groups, and one of the subgroups, and
when one main group among the plurality of main groups is selected and then a printing execution command in the cover installation mode is accepted, the printing control unit disposes the cover on the media bundle that is a bundle of the print materials belonging to one of the subgroups.

10. A non-transitory computer-readable storage medium storing a print data generation program of generating print data based on an acquired printing condition, the print data generation program being configured to cause a computer to execute:
displaying on a display device a user interface that accepts a setting of a printing position of a header for a case of disposing a cover at a media bundle that is a bundle of printed media and printing the header on the cover; and
generating print data in which the printing position acquired via the user interface is included in the printing condition.
